(19) United States
(12) Patent Application Publication
(10) Pub. No.: US 2023/0165191 A1
(43) Pub. Date: Jun. 1, 2023

(54) TRIMMER AND EDGER SYSTEM AND METHOD

(71) Applicant: MTD PRODUCTS INC, Valley City, OH (US)

(72) Inventors: Shalom Levin, Pardesiya (IL); Assaf Levin, Pardesiya (IL); Shai Abramson, Pardesiya (IL)

(21) Appl. No.: 18/071,832

(22) Filed: Nov. 30, 2022

Related U.S. Application Data
(60) Provisional application No. 63/284,264, filed on Nov. 30, 2021.

(51) Int. Cl. A01D 34/84; A01D 34/00; G05D 1/02

(52) U.S. Cl. CPC A01D 34/84; A01D 34/008; G05D 1/0212; A01D 2101/00

(57) ABSTRACT

Vehicle-mounted line trimmers and/or edgers for weed and vegetation, along with methods of operation of such trimmers, are discussed. The trimmer/edger can have a variety of features such as maintaining and/or adjusting the height of the trimmer/edger and maintaining the same orientation of the trimmer/edger at a variety of heights. The methods of operation can include methods for recording a path for the trimmer/edger and/or following a pre-recorded path for the trimmer/edger, trimming/edging around small obstacles, and trimming/edging along large obstacles.

### CROSS REFERENCE TO RELATED APPLICATIONS

This application claims the benefit of U.S. Provisional Application No. 63/284,264 filed Nov. 30, 2021 the entirety of which is hereby incorporated by reference.

### FIELD OF DISCLOSURE

This application relates generally to equipment for trimming and/or edging weeds and vegetation, and more specifically to equipment for trimming and/or edging that can be mounted on a lawn maintenance apparatus and/or another vehicle, and/or can be controlled in an autonomous or semi-autonomous manner.

### BACKGROUND

String or line trimmers use a length of line or wire attached to a rapidly rotating trimmer head to cut weeds and/or vegetation with the string or line. Line trimmers generally employ two trimming lines on opposite ends of the trimmer head, where the two lines are opposing ends of a single line hand-wound onto a reel. Line trimmers are available in both handheld and vehicle mounted varieties and can be controlled by a user and/or driver.

### SUMMARY

The following presents a simplified summary in order to provide a basic understanding of some example aspects of the disclosure. This summary is not an extensive overview. Moreover, this summary is not intended to identify critical elements of the disclosure nor delineate the scope of the disclosure. The sole purpose of the summary is to present some concepts in simplified form as a prelude to the more detailed description that is presented later.

According to one aspect, a first example embodiment is a trimmer for weeds and vegetation configured to be attached to a lawn maintenance apparatus, comprising: a trimmer head configured to at least one of trim or edge the weeds and the vegetation; a trimmer arm attached to the trimmer head configured to control a position of the trimmer head; and a trimmer base configured to connect the trimmer to the lawn maintenance apparatus and to control a position of the trimmer arm relative to the lawn maintenance apparatus.

According to another aspect, a second example embodiment is a method of operating a lawn maintenance apparatus with an attached trimmer, comprising: recording positions of the trimmer attached to the lawn maintenance apparatus along a path; making a determination to repeat the path; and autonomously controlling at least one of a position of the lawn maintenance apparatus or the trimmer to repeat the path.

According to a further aspect, a third example embodiment is a method of operating a lawn maintenance apparatus with an attached trimmer, comprising: making a first determination that the trimmer attached to the lawn maintenance apparatus is at an appropriate starting position for at least one of trimming or edging around an obstacle, wherein the trimmer is in contact with the obstacle; making a second determination that one or more wheels of the lawn maintenance apparatus are turned to an appropriate angle for the at least one of trimming or edging around the obstacle; and at least one of providing feedback to a user or autonomously controlling the lawn maintenance apparatus to maintain contact between the trimmer and the obstacle as the lawn maintenance apparatus circles the obstacle.

According to an additional aspect, a fourth example embodiment is a method of operating a lawn maintenance apparatus with an attached trimmer, comprising: making a first determination to begin at least one of trimming or edging with the trimmer along an obstacle in contact with the trimmer; monitoring a distance between the lawn maintenance equipment and the obstacle; and in response to a change in the distance between the lawn maintenance apparatus and the obstacle, at least one of providing feedback to a user or autonomously controlling the lawn maintenance apparatus to maintain contact between the trimmer and the obstacle.

To accomplish the foregoing and related ends, certain illustrative aspects of the disclosure are described herein in connection with the following description and the drawings. These aspects are indicative, however, of but a few of the various ways in which the principles of the disclosure can be employed and the subject disclosure is intended to include all such aspects and their equivalents. Other advantages and features of the disclosure will become apparent from the following detailed description of the disclosure when considered in conjunction with the drawings.

### BRIEF DESCRIPTION OF THE DRAWINGS

The foregoing and other aspects of the present disclosure will become apparent to those skilled in the art to which the present disclosure relates upon reading the following description with reference to the accompanying drawings, in which:

FIG. 1 illustrates an example embodiment of a lawn maintenance apparatus with an attached trimmer and/or edger system, in connection with various embodiments discussed herein.

FIG. 2 illustrates two images of an example embodiment of a trimmer system showing it in the trimming configuration (top image) and the edging configuration (bottom image), in connection with various aspects discussed herein.

FIG. 3 illustrates an image showing mechanisms of an example embodiment of trimmer arm that can be used to control positioning of trimmer, in connection with various embodiments.

FIG. 4 illustrates a pair of images showing mechanisms of an example embodiment of trimmer base with a suspension system for trimmer system, in connection with various embodiments.

FIG. 5 illustrates a perspective diagram showing trimmer arm and the suspension system, in connection with various aspects.

FIG. 6 illustrates a cutaway perspective diagram showing trimmer arm and the suspension system along with associated vectors, in connection with various aspects.

FIG. 7 illustrates are a pair of diagrams showing forces on the trimmer and trimmer arm and how roll balance springs can compensate for drag and/or gravity causing rotation of the trimmer and trimmer arm, in connection with various aspects discussed herein.

FIG. 8 illustrates three images of an example trimmer with an adjustable stand-off that can facilitate maintaining a selected distance from the ground and/or obstacles, in connection with various aspects discussed herein.

FIG. 9 illustrates a bottom perspective diagram of trimmer showing adjustable stand-offs (or skis) and along with an automatic string release, in connection with various aspects discussed herein.

FIG. 10 illustrates a top perspective diagram of a trimmer showing adjustment mechanisms for adjustable stand-offs (or skis), in connection with various aspects discussed herein.

FIG. 11 illustrates a cutaway view showing an example gear motor mechanism that can actuate the automatic string release, in connection with various aspects discussed herein.

FIG. 12 illustrates an image showing components of an example trimmer, in connection with various aspects discussed herein.

FIG. 13 illustrates a pair of images showing a trimmer holder that can be used to secure trimmer in a stowed or folded position when not in use, in connection with various aspects discussed herein.

FIG. 14 illustrates a diagram showing an example alternative embodiment of a trimmer head that can allow for simultaneous trimming and edging, in connection with various aspects discussed herein.

FIG. 15 illustrates a diagram showing that in various embodiments, a neutral position for a trimmer can be along the same line as a pivot point of (e.g., along a perpendicular line to the direction of travel of) a lawn maintenance apparatus, in connection with various embodiments.

FIG. 16 illustrates an example image of an embodiment of a trimmer system with an attached Global Positioning System (GPS) antenna, in connection with various aspects.

FIG. 17 illustrates a diagram showing an example of a first algorithm involving automatic positioning of trimmer arm based on following a pre-trained plan or pre-recorded path, in connection with various aspects discussed herein.

FIG. 18 illustrates a pair of diagrams showing an example of a second algorithm involving automatic trimming/edging around small obstacles, in connection with various aspects discussed herein.

FIG. 19 illustrates an image showing trimmer adjacent to a small obstacle for autonomous trimming around the obstacle, in connection with various aspects discussed herein.

FIG. 20 illustrates a diagram showing an example of a second algorithm involving automatic following of a large obstacle to maintain contact between trimmer and the obstacle, in connection with various aspects discussed herein.

FIG. 21 illustrates a second diagram showing another example of a second algorithm involving automatic following of a large obstacle to maintain contact between trimmer and the obstacle, in connection with various aspects discussed herein.

FIG. 22 illustrates a diagram showing a lawn maintenance equipment showing example locations at which one or more cameras, in accordance with various aspects discussed herein.

FIG. 23 illustrates a diagram showing an example method of a first example algorithm wherein GPS positions along a path of a trimmer can be recorded or determined and/or a pre-recorded path of GPS positions can be followed by a trimmer, in connection with various aspects discussed herein.

FIG. 24 illustrates a diagram showing an example method of a second example algorithm wherein rangefinding can be employed to facilitate trimming/edging around small obstacles, in connection with various aspects discussed herein.

FIG. 25 illustrates a diagram showing an example method of a second example algorithm wherein rangefinding can be employed to facilitate trimming/edging along large obstacles, in connection with various aspects discussed herein.

FIG. 26 illustrates a diagram of an example computing environment for electronic and data management and computer control for a lawn maintenance apparatus with attached trimmer system, according to various aspects discussed herein.

It should be noted that the drawings are diagrammatic and not drawn to scale. Relative dimensions and proportions of parts of the figures have been shown exaggerated or reduced in size for the sake of clarity and convenience in the drawings. The same reference numbers are generally used to refer to corresponding or similar features in the different embodiments, except where clear from context that same reference numbers refer to disparate features. Accordingly, the drawings and description are to be regarded as illustrative in nature and not as restrictive.

While specific embodiments of the disclosure pertaining to single line trimmers having continuous line feed are described herein, it should be understood that the disclosed systems, methods, and apparatuses are not so limited and modifications may be made without departing from the scope of the present disclosure. The scope of the systems, methods, and apparatuses are defined by the appended claims, and all devices, processes, and methods that come within the meaning of the claims, either literally or by equivalence, are intended to be embraced therein.

### DETAILED DESCRIPTION

Example embodiments that incorporate one or more aspects of the present disclosure are described and illustrated in the drawings. These illustrated examples are not intended to be a limitation on the present disclosure. For example, one or more aspects of the present disclosure can be utilized in other embodiments and even other types of devices. Moreover, certain terminology is used herein for convenience only and is not to be taken as a limitation on the present disclosure. Still further, in the drawings, the same reference numerals are employed for designating the same elements.

Various embodiments related to vehicle-mounted trimmers and/or edgers are discussed below. A first set of example embodiments discussed herein can be employed as a vehicle-mounted trimmer/edger, and a second set of example embodiments discussed herein comprise algorithms that can be employed for autonomous and/or semi-autonomous operation of a vehicle and vehicle-mounted trimmer/edger to perform trimming/edging. In various aspects, the first set of embodiments can be employed in connection with the second set of embodiments, although in other aspects, the first set of embodiments and the second set of embodiments can be employed separately (e.g., operating the first set of embodiments manually or in connection with other algorithms for autonomous or semi-autonomous operation, performing algorithm(s) of the second set of embodiments in connection with other trimmers and/or edgers, etc.).

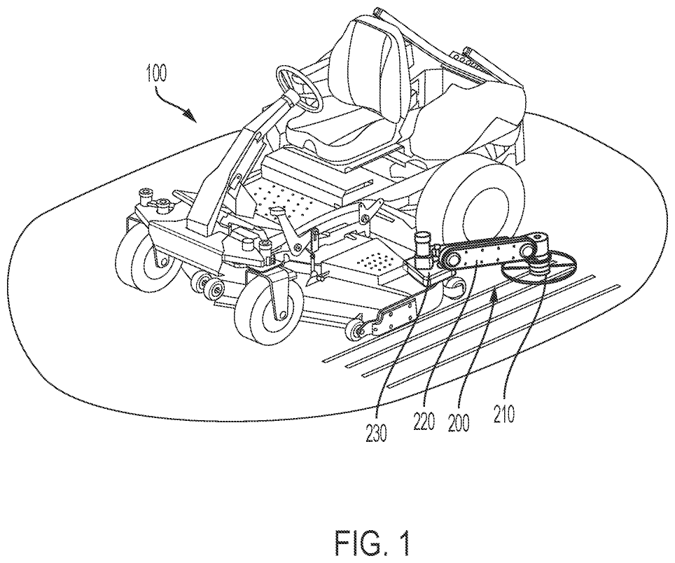

Referring to FIG. 1, illustrated is an example embodiment of a lawn maintenance apparatus 100 with an attached trimmer and/or edger system 200, in connection with various embodiments discussed herein. Trimmer/edger system 200 comprises a trimmer and/or edger 210 (also referred to herein as “trimmer,” which as used herein is intended to encompasses a trimmer, an edger, or a combination trimmer/edger) configured to trim and/or edge weeds and/or vegetation, and a trimmer arm 220 configured to position the trimmer 210. As can be seen in FIG. 1, in various embodiments, trimmer system 200 can be mounted on or near a side of lawn maintenance apparatus 100 or another vehicle at a trimmer base 230, such as attached to a mow deck of lawn maintenance apparatus 100, although in other embodiments, trimmer system 200 can be mounted at substantially any position on lawn maintenance apparatus 100 or another vehicle. In embodiments wherein trimmer system 200 is attached to a mow deck of lawn maintenance apparatus 100, height adjustment of trimmer system 200 can be accomplished via adjustment of the height of the mow deck of lawn maintenance apparatus 100.

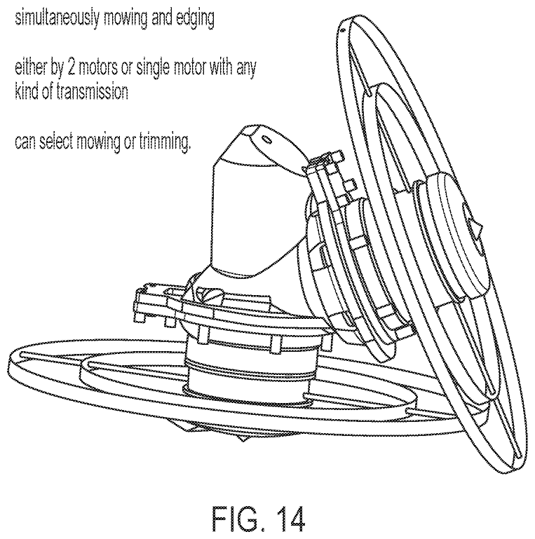

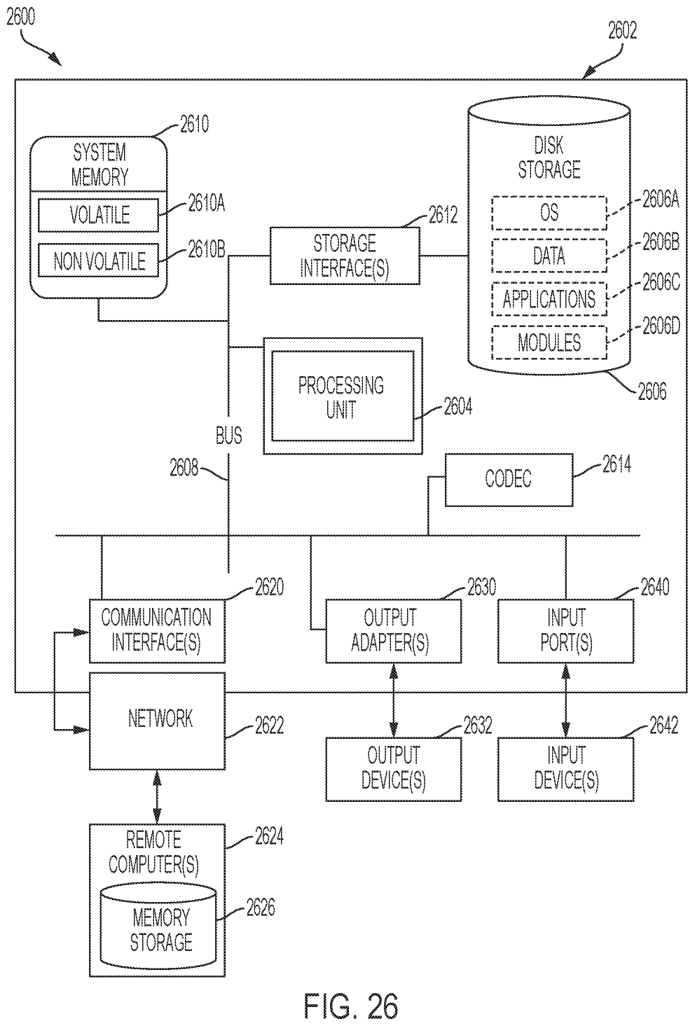

Trimmer system 200 can allow an operator of lawn maintenance apparatus 100 or another vehicle to easily perform trimming and/or edging while riding lawn maintenance apparatus 100 or another vehicle. Various embodiments of trimmer system 200 can be powered via a prime mover and/or power system of lawn maintenance apparatus 100 (e.g., battery, engine, alternator, etc.). Additionally, trimmer system 200 can be foldable such that it can be stowed in a position wherein it does not extend out from the vehicle when not in use (e.g., not shown in FIG. 1, but see FIG. 14 and the accompanying discussion below, etc.). In various embodiments, lawn maintenance apparatus can comprise a control unit and/or computer (e.g., as discussed in connection with FIG. 26, below, etc.) configured to control lawn maintenance apparatus 100 (e.g., steering, forward/reverse motion, etc.) and/or trimmer system 200 to perform various features and aspects discussed herein.

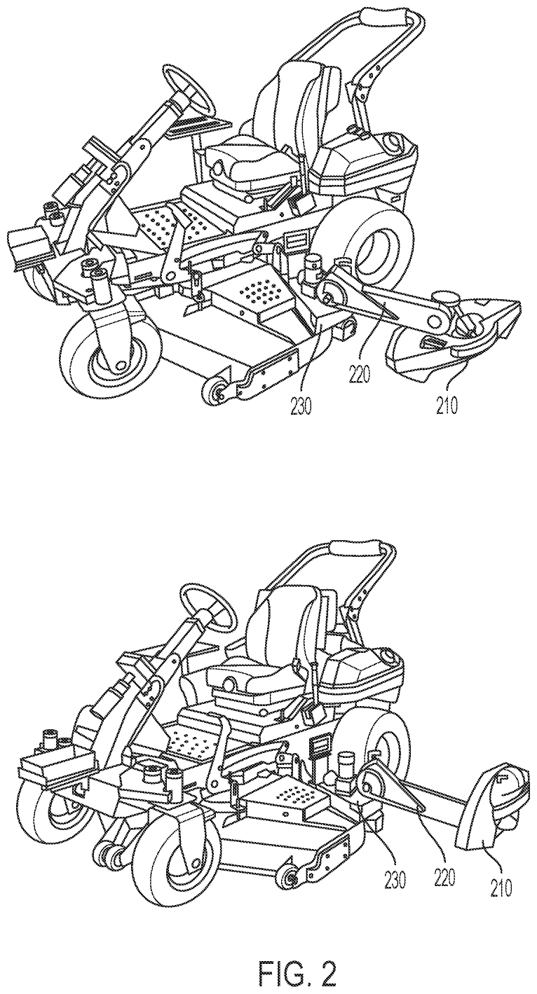

In various embodiments, trimmer 210 can be positioned alternately in both a trimming configuration (e.g., with a cutting plane (e.g., a plane of rotation of cutting lines, blades, etc.) substantially parallel to the ground, etc.) and an edging configuration (e.g., with a cutting plane substantially perpendicular to the ground, etc.). Referring to FIG. 2, illustrated are two images of an example embodiment of a trimmer system 200 showing it in the trimming configuration (top image) and the edging configuration (bottom image), in connection with various aspects discussed herein. In various embodiments, trimmer 210 can be switched manually between the trimming configuration (e.g., as shown in the top image of FIG. 2, etc.) and the edging configuration (e.g., as shown in the bottom image of FIG. 2, etc.), although other embodiments can automatically switch between these configurations (e.g., in response to user input, etc.) via one or more of mechanical, electrical, electromechanical, hydraulic, hydrostatic, pneumatic, etc. means.

Trimmer arm 220 can control the positioning of trimmer system 200 (and, in particular, trimmer 210), and can allow for multiple degrees of freedom (e.g., translational and/or rotational) in positioning trimmer system 200. For example, trimmer arm 220 can rotate horizontally and/or vertically about or near a connection point with lawn maintenance apparatus 100 or another vehicle.

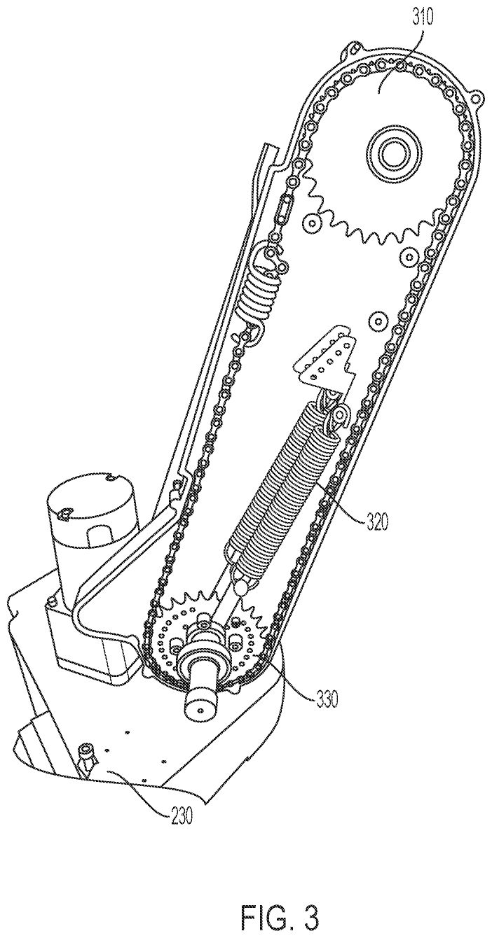

Referring to FIG. 3, illustrated is an image showing mechanisms of an example embodiment of trimmer arm 220 that can be used to control positioning of trimmer 210, in connection with various embodiments. At 310 is shown an outer gear of a parallelogram mechanism, whereby vertical rotation of trimmer arm 220 around an inner gear 330 (e.g., connected to trimmer base 230 that can be attached to a vehicle such as lawn maintenance apparatus 100) can be linked to rotation of trimmer 210 (e.g., via attachment to the outer gear 310), such that an angle of trimmer 210 relative to the ground can be maintained at all heights. Trimmer arm 220 can also comprise one or more springs 320, which can regulate a pressure of trimmer 210 on the ground, allowing trimmer head 210 to follow the contours of the ground. Additionally, although FIG. 3 and other images of example embodiments show mechanical means (e.g., springs, gears, etc.) of positioning trimmer system 200, other embodiments can similarly position trimmer system 200 via one or more of mechanical, electrical, electromechanical, hydraulic, hydrostatic, pneumatic, etc. means.

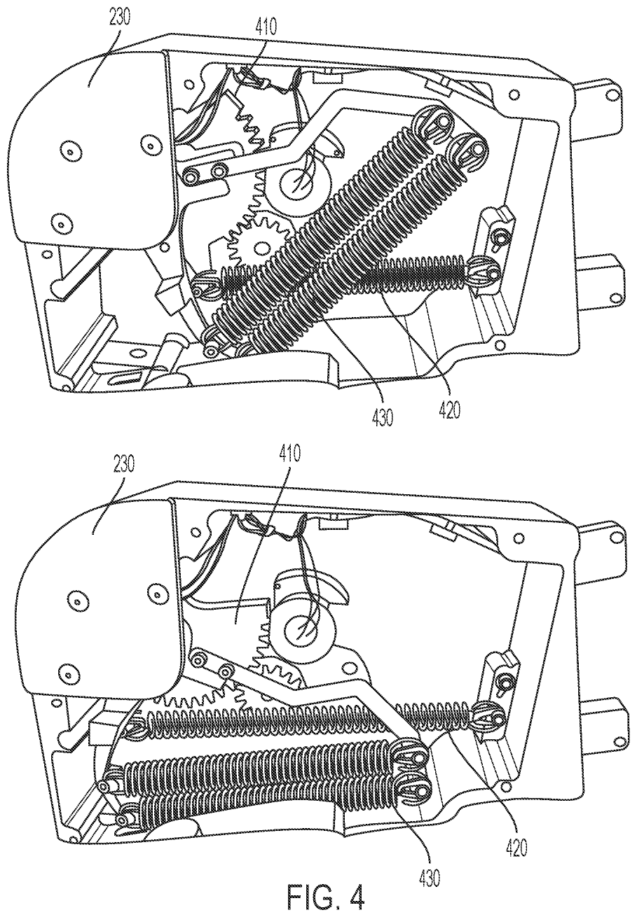

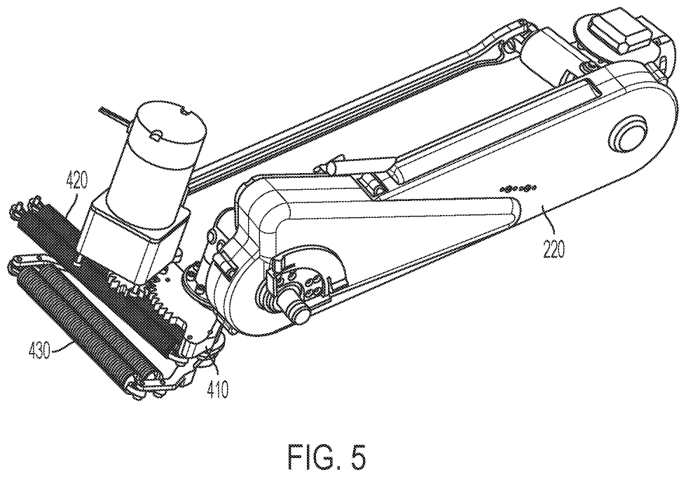

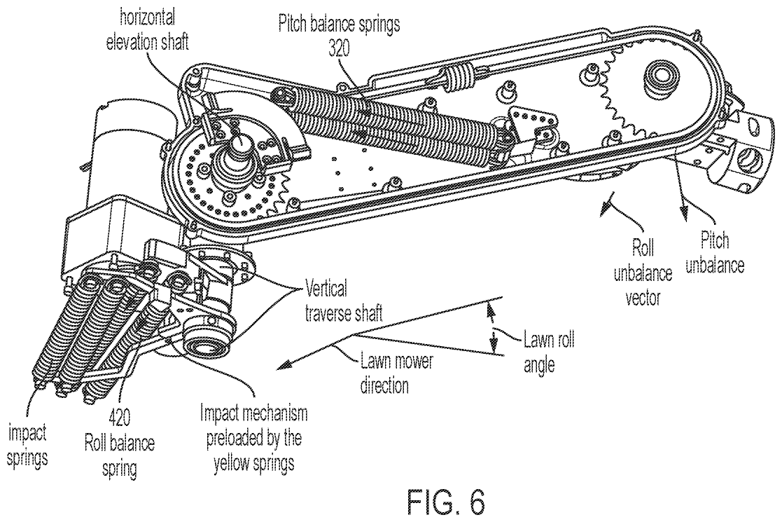

In various embodiments, trimmer system 200 can employ a suspension system such that trimmer 210 and trimmer arm 220 can recoil from or yield to impact (e.g., bumping into or pushing against obstacles such as trees, rocks, walls, etc.), and restore to an original position after the impact. Referring to FIG. 4, illustrated are a pair of images showing mechanisms of an example embodiment of trimmer base 230 with a suspension system 410-430 for trimmer system 200, in connection with various embodiments. Referring to FIG. 5, illustrated is a perspective diagram showing trimmer arm 220 and the suspension system 410-430, in connection with various aspects. Referring to FIG. 6, illustrated is a cutaway perspective diagram showing trimmer arm 220 and the suspension system 410-430 along with associated vectors, in connection with various aspects. FIGS. 4-6 shows one example embodiment of a suspension system 410-430 that can provide compensation for gravity (e.g., from slopes), drag, and/or impacts).

Impact springs 430 can help compensate for impacts, such that rotation of the trimmer arm 220 (corresponding to rotation of gear 410 from the top image of FIG. 4 to the bottom image of FIG. 4), for example, by yielding to an impact, stretches and/or compresses one or more springs 430, such that the spring(s) 430 can restore the trimmer arm 220 to its original position after the impact, and the same or other spring(s) 430 can be employed for rotation in an opposite direction (other embodiments can similarly facilitate trimmer system 200 recoiling from impacts and restoring its position via one or more of mechanical, electrical, electromechanical, hydraulic, hydrostatic, pneumatic, etc. means).

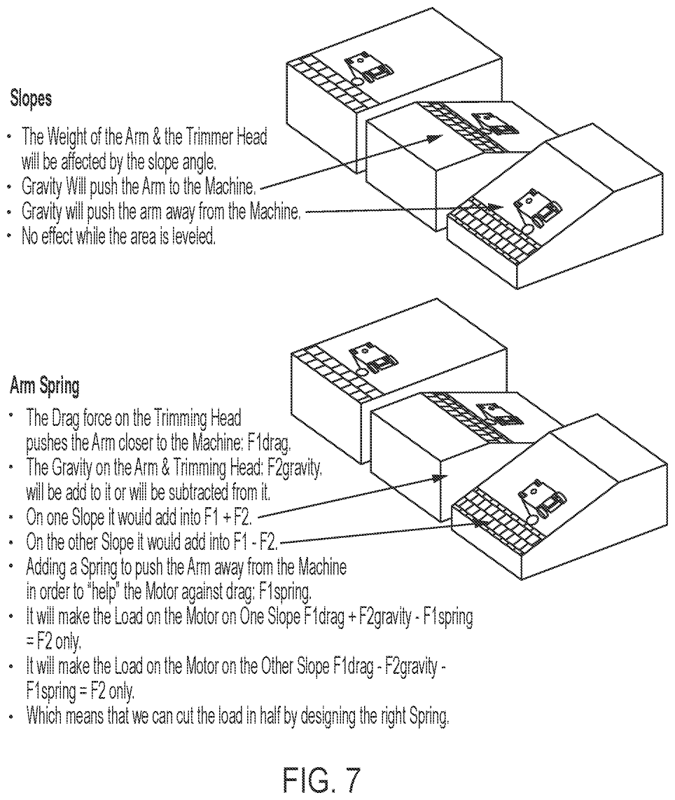

Referring to FIG. 7, illustrated are a pair of diagrams showing forces on the trimmer 210 and trimmer arm 220 and how roll balance springs 420 can compensate for drag and/or gravity causing rotation of the trimmer 210 and trimmer arm 220, in connection with various aspects discussed herein. As can be seen in the top diagram of FIG. 7, gravity will push the trimmer 210 and trimmer arm 220 toward the lawn maintenance apparatus 100 when trimmer 210 is above the lawn maintenance apparatus 100 on a slope, and away from the lawn maintenance apparatus 100 when trimmer 210 is below the lawn maintenance apparatus 100 on a slope (and will have no effect on level ground).

As seen in connection with the bottom image of FIG. 7, the component of drag pushing the trimmer 210 toward the lawn maintenance apparatus 100 can be referred to as F_{1drag}, and the component of gravity pushing the trimmer 210 toward or away from the lawn maintenance apparatus 100 can be referred to as F_{2gravity}. In the absence of roll balance springs 420, these forces combine for a net force of F_{1drag}+F_{2gravity} when the trimmer 210 is above the lawn maintenance apparatus 100 and combine for a net force of F_{1drag}−F_{2gravity} when the trimmer 210 is below the lawn maintenance apparatus 100. Various embodiments can include one or more elements of a suspension system, such as roll balance springs 420, which can push trimmer 210 and trimmer arm 220 away from the lawn maintenance apparatus to assist a motor of trimmer 210 (e.g., the gear motor coupled to gear 410, etc.) by offsetting the drag, e.g., by applying a force (F_{1spring}) with equal magnitude opposed to the drag force. With roll balance springs 420, the forces combine for a net force of F_{1drag}+F_{2gravity}−F_{1spring} (=F_{2gravity} only) when the trimmer 210 is above the lawn maintenance apparatus 100 and combine for a net force of F_{1drag}−F_{2gravity}−F_{1spring} (=−F_{2gravity} only) when the trimmer 210 is below the lawn maintenance apparatus 100, meaning that (with the right selection of roll balance spring(s) 420, etc.) the right selection of spring can cut the load on the motor in half or more (e.g., depending on the angle of the slope, etc.).

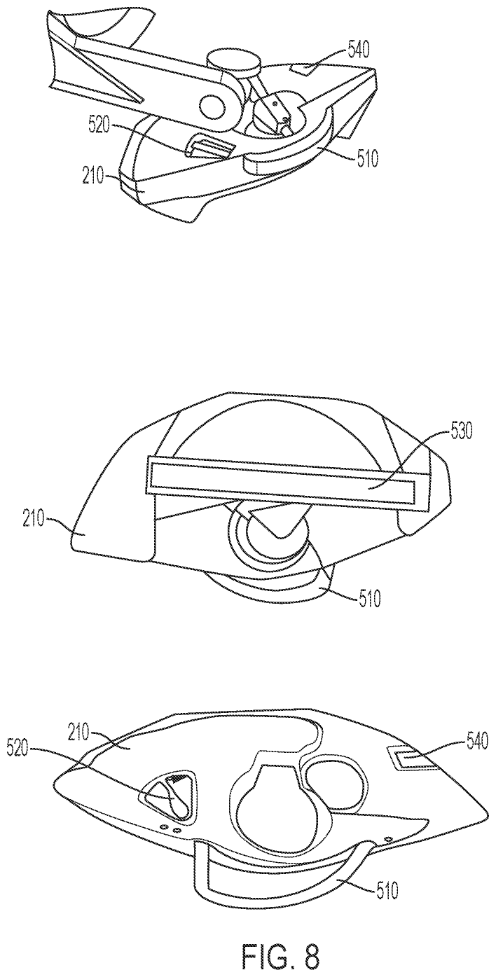

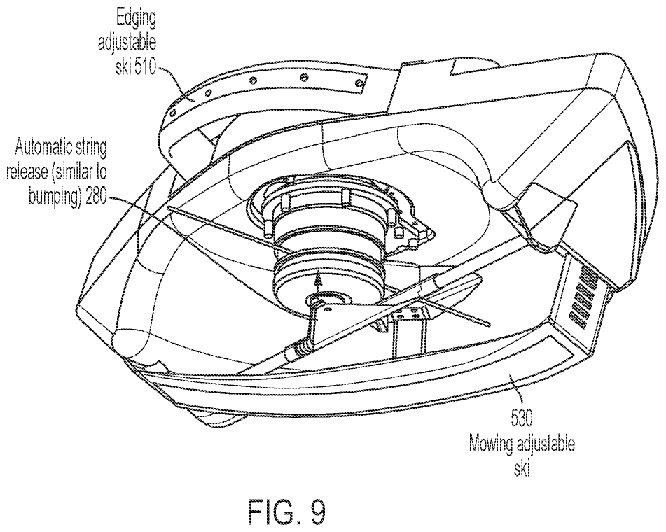

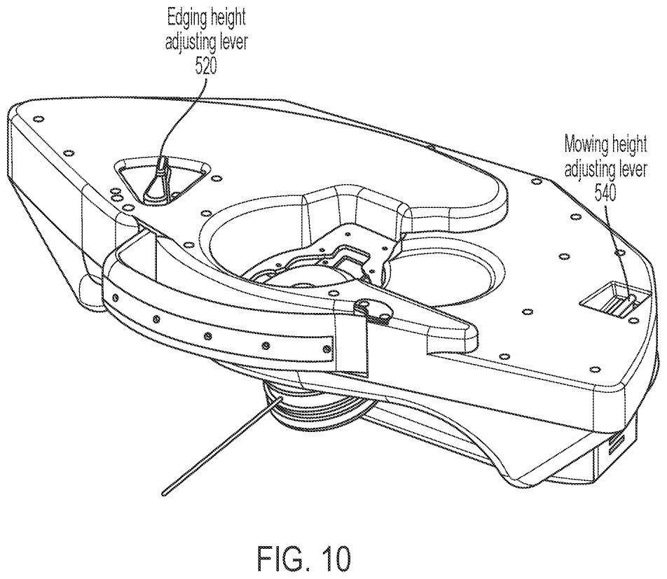

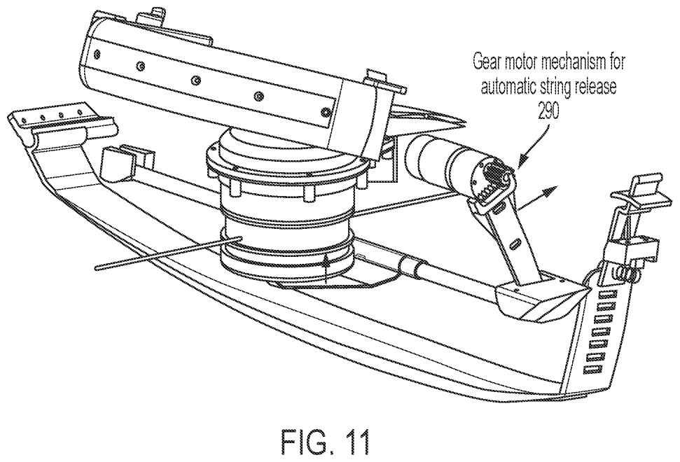

Referring to FIG. 8, illustrated are three images of an example trimmer 210 with an adjustable trimmer stand-off (or ski) 510 and/or adjustable edger stand-off (or ski) 530 that can facilitate maintaining a selected distance from the ground and/or obstacles, in connection with various aspects discussed herein. Referring to FIG. 9, illustrated is a bottom perspective diagram of trimmer 210 showing adjustable stand-offs (or skis) 510 and 530 along with automatic string release 280, in connection with various aspects discussed herein. Referring to FIG. 10, illustrated is a top perspective diagram of trimmer 210 showing adjustment mechanisms 520 and 540 for adjustable stand-offs (or skis) 510 and 530, in connection with various aspects discussed herein. Referring to FIG. 11, illustrated is a cutaway view showing an example gear motor mechanism 290 that can actuate the automatic string release 280, in connection with various aspects discussed herein. Example trimmer 210 comprises an adjustment mechanism 520 to allow for manual adjustment of the distance provided by the stand-off 510 (e.g., the bottom image provides a greater distance via stand-off 510 than the top image). Adjustment mechanism 520 can allow for selection of several different positions for stand-off 510 and can secure stand-off 510 in a selected position. Similarly, adjustment mechanism 540 can allow for manual adjustment of and selection of several different positions for stand-off 530 and can secure stand-off 510 in a selected position. Although shown in connection with an embodiment mounted on a lawn maintenance apparatus, adjustable stand-offs 510 and 530 and their adjustment mechanisms 520 and 540 can also be employed on hand-held trimmers and/or edgers.

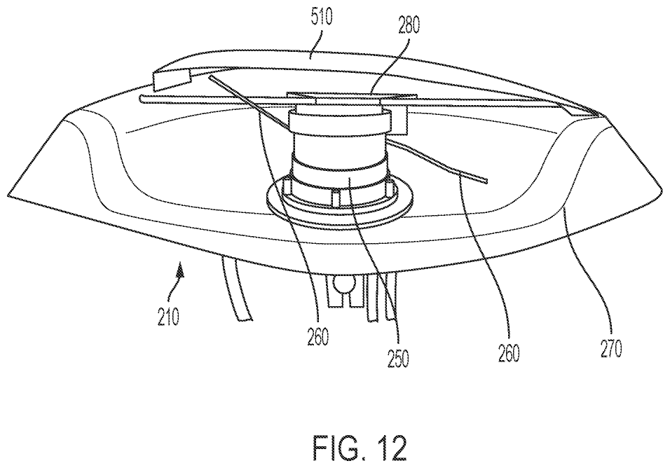

Referring to FIG. 12, illustrated is a pair of images showing components of an example trimmer 210, in connection with various aspects discussed herein. These components can comprise a rotating trimmer head 250, one or more trimmer lines 260, and/or a trimmer shield 270. Additionally, trimmer 210 can include an automatic string release mechanism 280 to facilitate replacement of trimmer line(s) 260, which can operate as described above.

String trimmer cartridges employed in bump trimmers work via centrifugal force, wherein depressing a button on the end allows the wire/string to extend via centrifugal force, which can be cut by a static blade when it exceeds a given length. Release mechanism 280 can be actuated (e.g., via gear motor mechanism 290) manually or automatically (e.g., based on a sensor detecting that the wire is short) to release wire or string from a replaceable or reloadable cartridge. In various embodiments, a fixed amount of wire/string can be released per actuation or actuation can continuously release wire/string until ended.

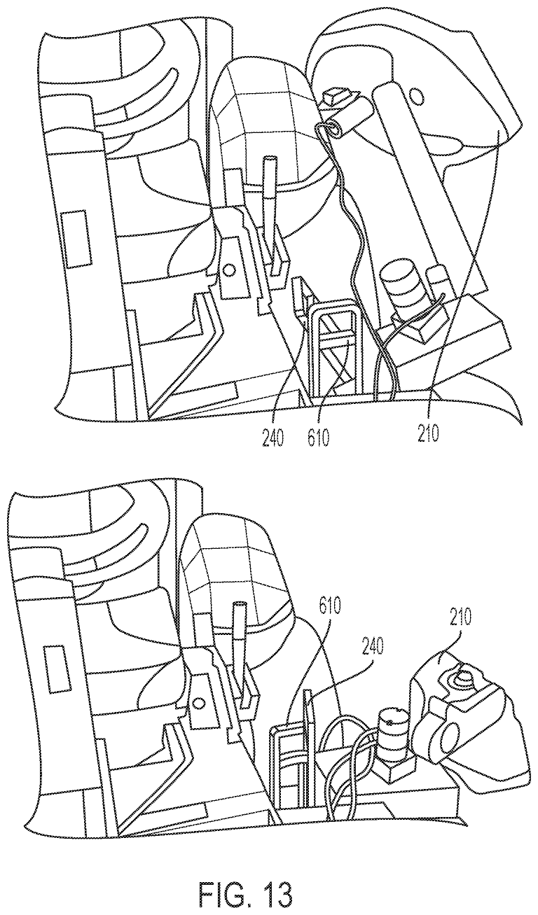

Referring to FIG. 13, illustrated is a pair of images showing a trimmer holder 610 that can be used to secure trimmer 210 in a stowed or folded position when not in use, in connection with various aspects discussed herein. In various embodiments, trimmer system 200 can comprise a lever arm 240 that can engage and/or disengage with trimmer holder 610 to secure and/or release trimmer system 200 from trimmer holder 610, respectively.

Referring to FIG. 14, illustrated is a diagram showing an example alternative embodiment of a trimmer head that can allow for simultaneous trimming and edging, in connection with various aspects discussed herein. In various embodiments, instead of trimmer head 250 of example trimmer 200, an alternative trimmer head can be employed that can allow for simultaneous trimming and edging and/or can allow for changing between trimming and edging without adjusting a position or orientation of the trimmer head.

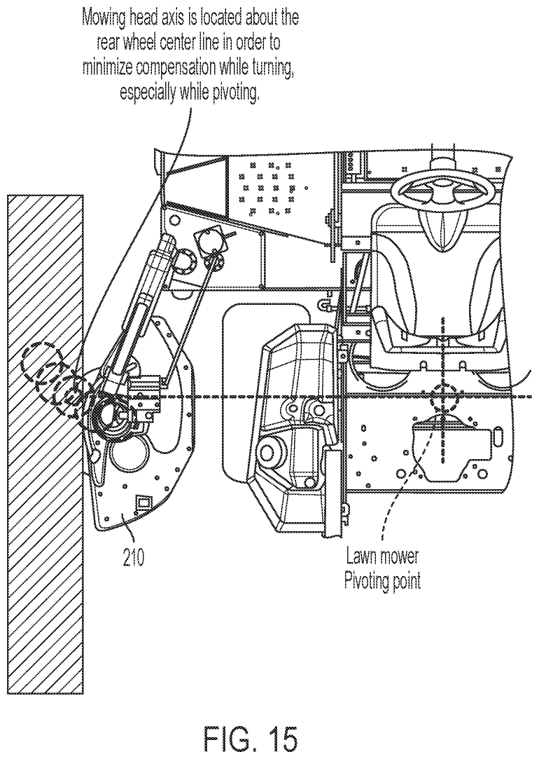

Referring to FIG. 15, illustrated is a diagram showing that in various embodiments, a neutral position for a trimmer 210 can be along the same line as a pivot point of (e.g., along a perpendicular line to the direction of travel of) lawn maintenance apparatus 100, in connection with various embodiments. The neutral position can be a position toward which a suspension system (e.g., 410-430) is biased to restore the trimmer head 210. By setting this neutral point to be on a line at or near the pivot point (e.g., for zero turning and/or autonomous/semi-autonomous trimming/edging around small obstacles, etc.), compensation to maintain the position of trimmer 210 can be minimized while turning.

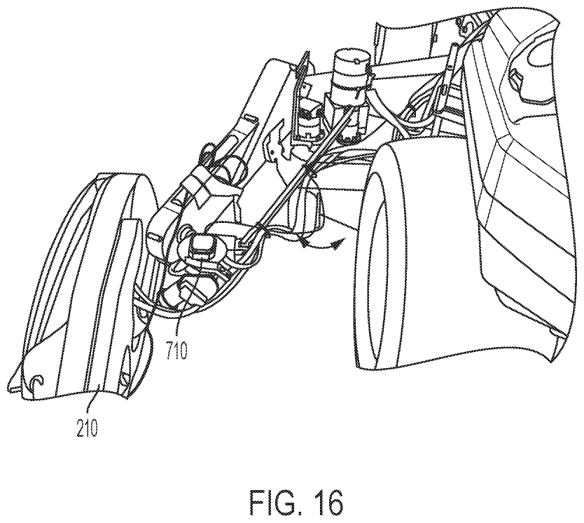

Referring to FIG. 16, illustrated is an example image of an embodiment of a trimmer system 200 with an attached Global Positioning System (GPS) antenna 710, in connection with various aspects. In various embodiments, GPS-RTK (Real Time Kinematics) can be employed to accurately determine the position (e.g., within around 2 cm) of GPS antenna 710. Based on the known GPS position of the GPS antenna 710 and the position of trimmer 210 relative to GPS antenna 710, the GPS position of trimmer 210 can be determined. Depending on the embodiments, one or more GPS antennas 710 can be mounted on trimmer 200 and/or lawn maintenance apparatus 100. Various embodiments can employ one or more algorithms in connection with GPS antenna(s) 710, such as recording a path for the trimmer 210 that can later be replicated by autonomous or semi-autonomous control of trimmer arm 220 and/or lawn maintenance apparatus 100, as discussed in greater detail below.

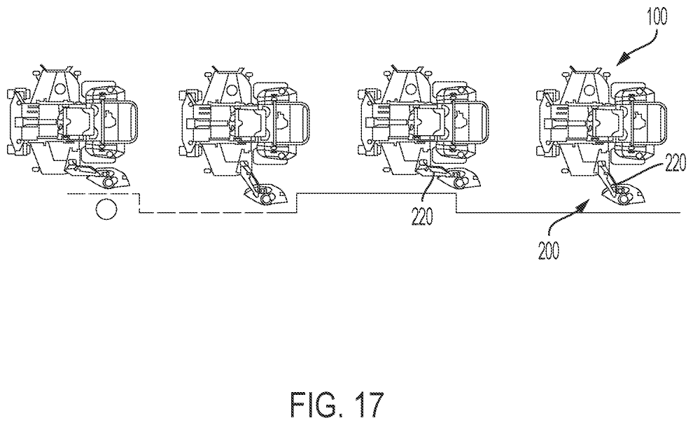

Referring to FIG. 17, illustrated is a diagram showing an example of a first algorithm involving automatic positioning of trimmer arm 220 based on following a pre-trained plan or pre-recorded path, in connection with various aspects discussed herein. During an initial or training period, a position of the trimmer 210 can be determined and recorded for a path followed by an operator of the trimmer system 200 and/or lawn maintenance apparatus 100, which can later be replicated (for example, via user input when at or near the start of the path, etc.) by autonomous control of the position of the trimmer arm 220 and/or lawn maintenance apparatus 100 to ensure that trimmer 210 follows the pre-recorded path. This technique can be used to follow any user-defined path, such as soft edges (e.g., around landscaping, at property boundaries, etc.) that cannot easily be determined via range-finding (e.g., ultrasonic, vision-based, etc.).

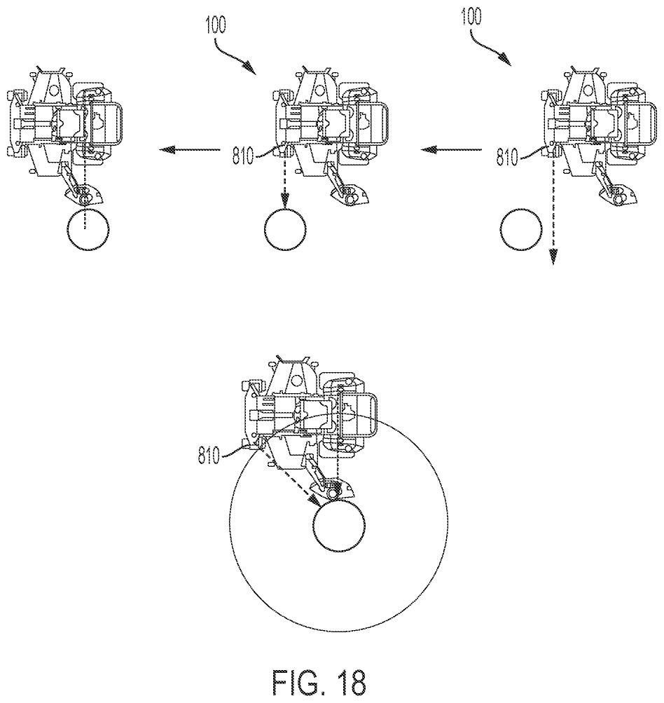

Referring to FIG. 18, illustrated is a pair of diagrams showing an example of a second algorithm involving automatic trimming/edging around small obstacles, in connection with various aspects discussed herein. As can be seen in the top diagram of FIG. 18, range-finding (e.g., ultrasonic, laser, stereo vision, LIDAR, etc.) can be employed to determine a starting point for trimming/edging around a small (e.g., circular, etc.) obstacle such as a tree, rock, telephone pole, lamppost, pillar, etc. The starting point can be a closest point along a path passing near enough to the obstacle (e.g., within reach of trimmer 200, etc.), which can be determined by a rangefinder 810 (e.g., ultrasonic, etc.). In some embodiments, lawn maintenance apparatus 100 can approach and stop at (or transition to trimming/edging around the obstacle) an acceptable starting point autonomously or can provide feedback (e.g., one or more of visual, auditory, tactile, etc.) to an operator of lawn maintenance apparatus 100 when at an acceptable starting point.

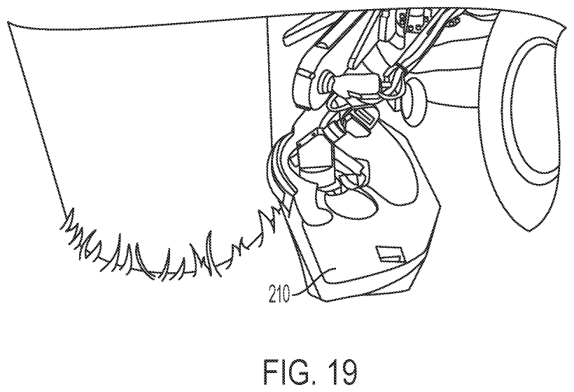

After determining a starting point for trimming/edging around the obstacle (e.g., the leftmost lawn maintenance equipment in the top image of FIG. 18, with trimmer 210 positioned adjacent to the obstacle, etc.), steerable wheel(s) of lawn maintenance equipment can be automatically turned to an appropriate angle to trim/edge around the obstacle (e.g., maintaining contact between the trimmer 210 and the obstacle, etc.). In various embodiments, the rangefinder 810 can be mounted on or can otherwise turn with a steerable wheel of the lawn maintenance equipment, such that rotation of the wheel (e.g., autonomously or manually, etc.) can aim the rangefinder at the obstacle (e.g., as seen in the bottom image of FIG. 18, etc.), which can ensure that the distance between the lawn maintenance apparatus 100 and obstacle is within reach of the trimmer 210 (e.g., based on the range of motion of trimmer arm 220, etc.), such that trimmer 210 can remain in contact with the obstacle. In various embodiments, motion of the lawn maintenance apparatus 100 (e.g., forward around the obstacle, etc.) also can be autonomously controlled, such that lawn maintenance apparatus 100 can be autonomously controlled (e.g., via control of both steering and forward motion, etc.) to circle around the obstacle while keeping trimmer 210 in optimal position for trimming/edging. Alternatively, forward motion and/or steering can be performed manually, and a user optionally can be provided feedback to maintain appropriate distance from the obstacle. Referring to FIG. 19, illustrated is an image showing trimmer 210 adjacent to a small obstacle for autonomous trimming around the obstacle, in connection with various aspects discussed herein. In various embodiments, a suspension system on a trimmer system (e.g., such as the example suspension system described above, etc.) can be used to ensure that the trimmer 210 remains in contact with the obstacle while trimming/edging around the obstacle.

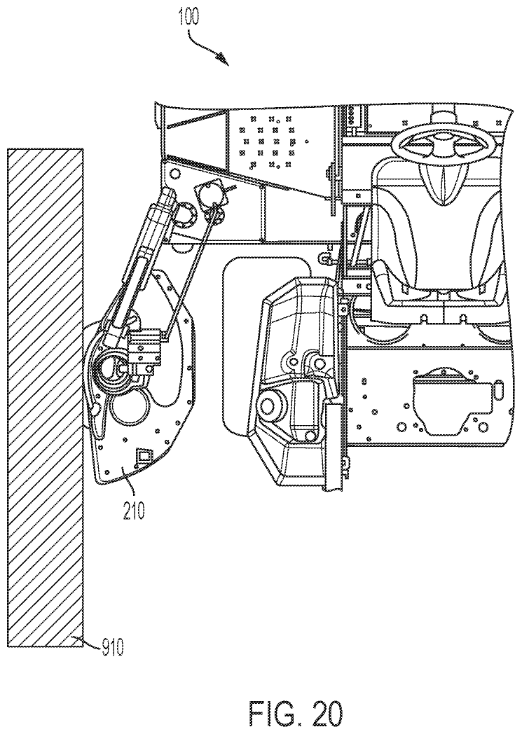

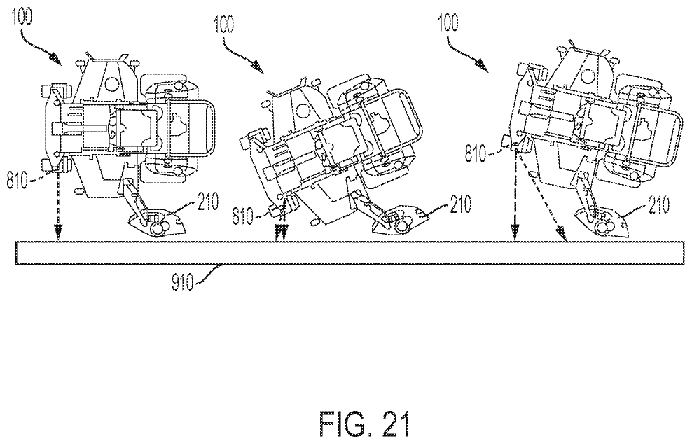

Referring to FIG. 20, illustrated is a diagram showing an example of a second algorithm involving automatic following of a large obstacle 910 to maintain contact between trimmer 210 and the obstacle, in connection with various aspects discussed herein. Referring to FIG. 21, illustrated is a second diagram showing another example of a second algorithm involving automatic following of a large obstacle 910 to maintain contact between trimmer 210 and the obstacle, in connection with various aspects discussed herein. As can be seen in FIG. 21, variations in distance to the obstacle can be measured by rangefinder 810. This distance information can be used to determine if the lawn maintenance apparatus 100 is at an acceptable distance, too close (at or approaching a minimum possible distance (e.g., based on threshold distance(s) and/or speed information determined from multiple distance measurements, etc.) between the lawn maintenance equipment 100 and obstacle 910, based on a range of motion of trimmer 210) or too far (at or approaching a maximum possible distance (e.g., based on threshold distance(s) and/or speed information determined from multiple distance measurements, etc.) between the lawn maintenance equipment 100 and obstacle 910, based on a range of motion of trimmer 210), and to provide user feedback and/or autonomously steer the lawn maintenance apparatus 100 based on a determination that the lawn maintenance apparatus 100 is either too close or too far from obstacle 910. In various embodiments, a suspension system on a trimmer system (e.g., such as the example suspension system described above, etc.) can be used to ensure that the trimmer 210 remains in contact with the obstacle while trimming/edging along the obstacle.

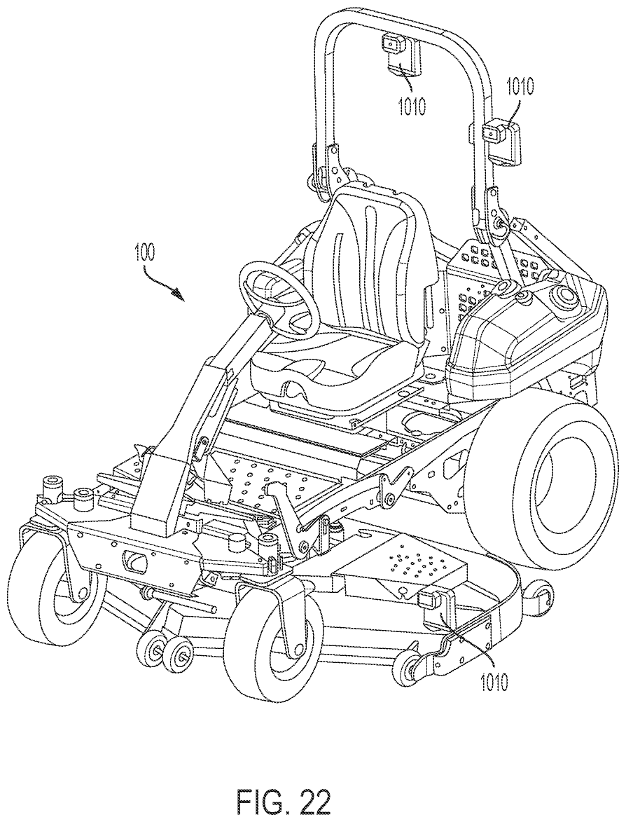

Referring to FIG. 22, illustrated is a diagram showing a lawn maintenance equipment 100 showing example locations at which one or more cameras 1010, in accordance with various aspects discussed herein. In various embodiments, vision based techniques can be employed for autonomous or semi-autonomous edging or trimming, including following soft edges based on visually distinguishable features (e.g., grass of different heights, grass and another material such as mulch, concrete, stone, etc.), even if a path is not pre-recorded.

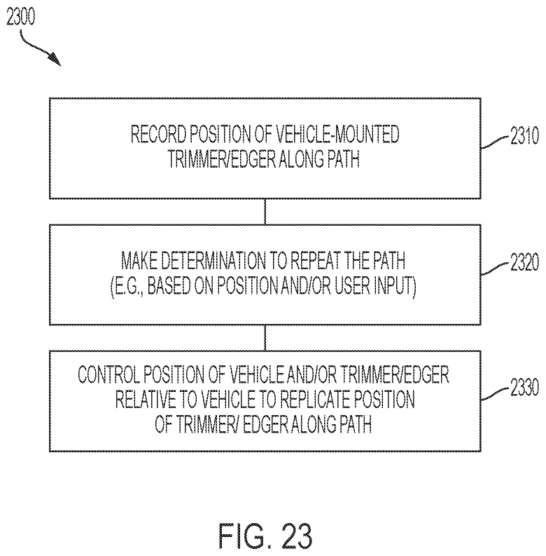

In view of the exemplary diagrams described above, process methods that can be implemented in accordance with the disclosed subject matter will be better appreciated with reference to the flow charts of FIGS. 23-25. While for purposes of simplicity of explanation, the methods of FIGS. 23-25 are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein, and in some embodiments additional steps known in the art or reasonably conveyed to one of ordinary skill in the art by way of the context provided herein are also considered within the scope of the present disclosure. Moreover, some steps illustrated as part of one process can be implemented for another process where suitable; other steps of one or more processes can be added or substituted in other processes disclosed herein within the scope of the present disclosure. Additionally, it should be further appreciated that the methods disclosed throughout this specification are capable of being stored on an article of manufacture to facilitate transporting and transferring such methodologies to an electronic device. The term article of manufacture, as used, is intended to encompass a computer program accessible from any computer-readable device, device in conjunction with a carrier, or storage medium.

Referring to FIG. 23, illustrated is a diagram showing an example method 2300 of a first example algorithm wherein GPS positions along a path of a trimmer can be recorded or determined and/or a pre-recorded path of GPS positions can be followed by a trimmer, in connection with various aspects discussed herein. In various embodiments, this algorithm can be initiated and/or ended in response to user input and/or sensor determination.

At 2310, the position of a trimmer (e.g., trimmer 210) can be recorded along a path (e.g., as a user operates lawn maintenance apparatus 100, etc.). In some embodiments, a GPS antenna (e.g., GPS antenna 710, etc.) can be mounted on or at a fixed relative distance to the trimmer, such that the GPS position of the trimmer can be readily known from the GPS position of the GPS antenna. In other embodiments, a GPS antenna can be mounted on the lawn maintenance equipment, and the GPS position of the trimmer can be determined from the GPS position of the antenna and other information, such as the position of a trimmer arm (e.g., trimmer arm 220, etc.) relative to the GPS antenna, etc.

At 2320, a determination can be made to repeat the path recorded at 2310. In various embodiments, this determination can be based on a current GPS position of the lawn maintenance apparatus or trimmer being at or near either end of the path and/or user input, such as within a threshold distance of either end (e.g., within the reach of trimmer 210, etc.). In various embodiments, user feedback can be provided to indicate when the current GPS position of the lawn maintenance apparatus or trimmer is at or near either end of the path.

At 2330, the position of the trimmer can be controlled to track the path recorded at 2310 by autonomously controlling one or more of the position of the trimmer relative to the vehicle, the direction of the vehicle (e.g., steering, etc.), or the motion of the vehicle (e.g., driving forward, etc.). Autonomous control can continue until the trimmer reaches the other end of the path from where it began.

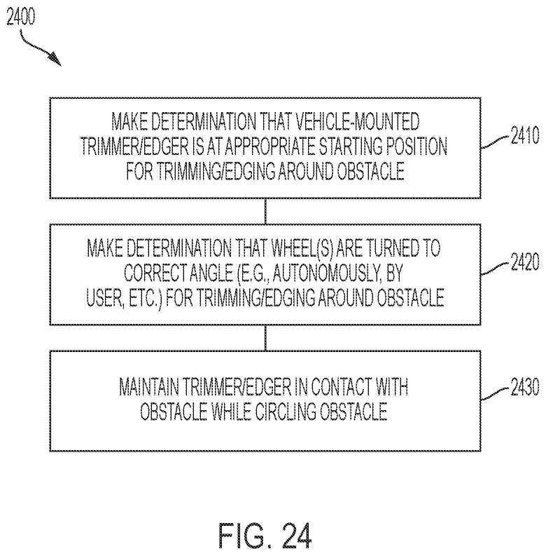

Referring to FIG. 24, illustrated is a diagram showing an example method 2400 of a second example algorithm wherein rangefinding can be employed to facilitate trimming/edging around small obstacles, in connection with various aspects discussed herein. In various embodiments, this algorithm can be initiated and/or ended in response to user input and/or sensor determination.

At 2410, a determination can be made that a trimmer (e.g., trimmer 210, etc.) mounted on a lawn maintenance apparatus (e.g., lawn maintenance apparatus 100, etc.) or the lawn maintenance apparatus is at or near an appropriate position for trimming/edging around a small obstacle. An appropriate position can be one in which the trimmer is at a tangent point of the small obstacle, for example.

At 2420, a determination can be made that steerable wheels of the lawn maintenance apparatus have been turned (e.g., autonomously or by a user, etc.) to an appropriate angle for trimming/edging around the obstacle, e.g., via a rangefinder, as discussed herein. The appropriate angle can be an angle that will maintain a distance between the lawn maintenance apparatus and the obstacle, which can be determined by aiming a rangefinder placed on the steerable wheel (e.g., and aimed perpendicular to that wheel, etc.) toward a center of the obstacle (e.g., which can be a nearest point on the obstacle to the rangefinder when the vehicle is in position, etc.), which can correspond to the steerable wheel being perpendicular to a radius extending from the center of the obstacle. In various embodiments, feedback can be provided to a user that autonomous or semi-autonomous trimming/edging around the obstacle can begin, or such trimming/edging can begin automatically.

At 2430, steering and/or driving of the lawn maintenance apparatus each can be controlled autonomously or can have user feedback provided, which can be based on a distance between the lawn maintenance apparatus and the small obstacle (e.g., as determined by the rangefinder, etc.), to maintain contact between the trimmer and the obstacle as the lawn maintenance apparatus circles the obstacle.

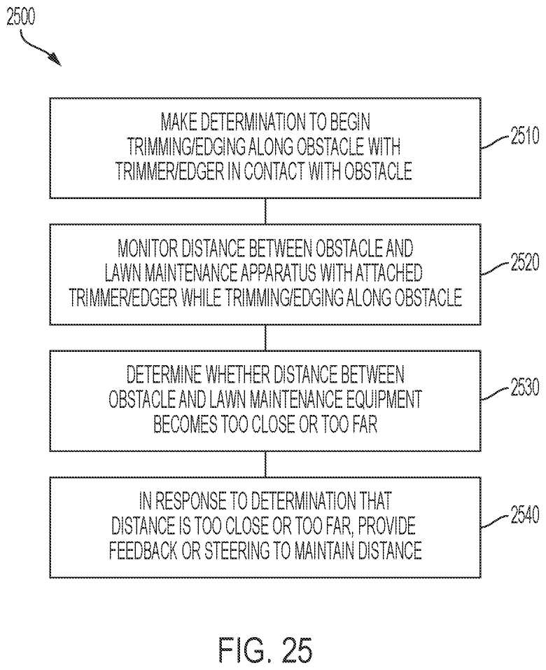

Referring to FIG. 25, illustrated is a diagram showing an example method 2500 of a second example algorithm wherein rangefinding can be employed to facilitate trimming/edging along large obstacles, in connection with various aspects discussed herein. In various embodiments, this algorithm can be initiated and/or ended in response to user input and/or sensor determination.

At 2510, a determination can be made to begin trimming/edging along an obstacle with a trimmer (e.g., trimmer 210, etc.) attached to a lawn maintenance apparatus (e.g., lawn maintenance apparatus 100, etc.). In various embodiments, the determination can be made based on a sensed distance to the obstacle (e.g., with reach of the trimmer, etc.) and/or user input.

At 2520, while trimming/edging with a trimmer (e.g., trimmer 210, etc.) along (e.g., in contact with, etc.) the obstacle (e.g., autonomously and/or manually, etc.), the distance between the obstacle and the lawn maintenance apparatus (e.g., lawn maintenance apparatus 100, etc.) can be monitored by a rangefinder (e.g., rangefinder 710, etc.).

At 2530, determination(s) can be made whether the distance between the obstacle and lawn maintenance equipment has become too close or too far (e.g., based on threshold distance(s) which can depend on a reach of the trimmer and/or based on a speed determined from changes in the distance between the obstacle and lawn maintenance apparatus, etc.).

At 2540, in response to a determination that the distance is too close or too far, user feedback can be provided and/or steering can be controlled autonomously to maintain the distance between the lawn maintenance apparatus and obstacle within a range sufficient for the trimmer to remain in contact with the obstacle.

Referring to FIG. 26, illustrated is a diagram of an example computing environment for electronic and data management and computer control for a lawn maintenance apparatus with attached trimmer system, according to various aspects discussed herein. In connection with FIG. 26, the systems and processes described herein can be embodied within hardware, such as a single integrated circuit (IC) chip, multiple ICs, an application specific integrated circuit (ASIC), or the like. A suitable operating environment 2600 for implementing various aspects of the claimed subject matter includes a computer 2602. In various embodiments, a control unit (e.g., of lawn maintenance apparatus 100, such as for controlling lawn maintenance apparatus 100 and/or trimmer system 200, etc.) of a lawn maintenance apparatus can be embodied in part by computer 2602, or an analogous computing device known in the art, subsequently developed, or made known to one of ordinary skill in the art by way of the context provided herein.

The computer 2602 includes a processing unit 2604, a system memory 2610, a codec 2614, and a system bus 2608. The system bus 2608 couples system components including, but not limited to, the system memory 2610 to the processing unit 2604. The processing unit 2604 can be any of various available processors. Dual microprocessors and other multiprocessor architectures also can be employed as the processing unit 2604.

The system bus 2608 can be any of several types of bus structure(s) including the memory bus or memory controller, a peripheral bus or external bus, or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 2610 can include volatile memory 2610A, non-volatile memory 2610B, or both. Functions of a control unit (among other control units: 150, etc., depicted herein) described in the present specification can be programmed to system memory 2610, in various embodiments. The basic input/output system (BIOS), containing the basic routines to transfer information between elements within the computer 2602, such as during start-up, is stored in non-volatile memory 2610B. In addition, according to present innovations, codec 2614 may include at least one of an encoder or decoder, wherein the at least one of an encoder or decoder may consist of hardware, software, or a combination of hardware and software. Although, codec 2614 is depicted as a separate component, codec 2614 may be contained within non-volatile memory 2610B. By way of illustration, and not limitation, non-volatile memory 2610B can include read only memory (ROM), programmable ROM (PROM), electrically programmable ROM (EPROM), electrically erasable programmable ROM (EEPROM), or Flash memory. Non-volatile memory 2610B can be embedded memory (e.g., physically integrated with computer 2602 or a mainboard thereof), or removable memory. Examples of suitable removable memory can include a secure digital (SD) card, a compact Flash (CF) card, a universal serial bus (USB) memory stick, or the like. Volatile memory 2610A includes random access memory (RAM), which can serve as operational system memory for applications executed by processing unit 2604. By way of illustration and not limitation, RAM is available in many forms such as static RAM (SRAM), dynamic RAM (DRAM), synchronous DRAM (SDRAM), double data rate SDRAM (DDR SDRAM), and enhanced SDRAM (ESDRAM), and so forth.

Computer 2602 may also include removable/non-removable, volatile/non-volatile computer storage medium. FIG. 26 illustrates, for example, disk storage 2606. Disk storage 2606 includes, but is not limited to, devices such as a magnetic disk drive, solid state disk (SSD) floppy disk drive, tape drive, Flash memory card, memory stick, or the like. In addition, disk storage 2606 can include storage medium separately or in combination with other storage medium including, but not limited to, an optical disk drive such as a compact disk ROM device (CD-ROM) or derivative technology (e.g., CD-R Drive, CD-RW Drive, DVD-ROM, and so forth). To facilitate connection of the disk storage 2606 to the system bus 2608, a removable or non-removable interface is typically used, such as interface 2612. In one or more embodiments, disk storage 2606 can be limited to solid state non-volatile storage memory, providing motion and vibration resistance for a control unit operable in conjunction with a lawn maintenance apparatus (e.g., lawn maintenance apparatus 100, etc.) and/or trimmer system (e.g., trimmer system 200, etc.).

It is to be appreciated that FIG. 26 describes software that can program computer 2602 to operate as an intermediary between a user of a lawn maintenance apparatus (e.g., lawn maintenance apparatus 100, etc.) and/or trimmer system (e.g., trimmer system 200, etc.), or operate as an intermediary between the lawn maintenance apparatus and/or trimmer system and an autonomous control system (or partially autonomous) for operating the lawn maintenance apparatus and/or trimmer system embodied within operating environment 2600. Such software includes an operating system 2606A. Operating system 2606A, which can be stored on disk storage 2606, acts to control and allocate resources of the computer 2602. Applications 2606C take advantage of the management of resources by operating system 2606A through program modules 2606D, and program data 2606B, such as the boot/shutdown transaction table and the like, stored either in system memory 2610 or on disk storage 2606. It is to be appreciated that the claimed subject matter can be implemented with various operating systems or combinations of operating systems.

Input device(s) 2642 connects to the processing unit 2604 and facilitates user interaction with operating environment 2600 through the system bus 1008 via interface port(s) 2630. Input port(s) 2640 can include, for example, a serial port, a parallel port, a game port, a universal serial bus (USB), among others. Output device(s) 2632 use some of the same type of ports as input device(s) 2642. Thus, for example, a USB port may be used to provide input to computer 2602 and to output information from computer 2602 to an output device 2632. Output adapter 2630 is provided to illustrate that there are some output devices, such as graphic display, speakers, and printers, among other output devices, which require special adapters. The output adapter 2630 can include, by way of illustration and not limitation, video and sound cards that provide a means of connection between the output device 2632 and the system bus 2608. It should be noted that other devices or systems of devices provide both input and output capabilities such as remote computer(s) 2624 and memory storage 2626.

Computer 2602 can operate in conjunction with one or more electronic devices described herein. For instance, computer 2602 can embody a lawn maintenance apparatus control unit configured to operate a trimmer system 200, a steering interface system of lawn maintenance equipment 100 and/or a motor of lawn maintenance equipment 100 to provide autonomous or semi-autonomous driving and/or autonomous control over trimmer system 200, as described herein.

Communication connection(s) 2620 refers to the hardware/software employed to connect the network interface 2622 to the system bus 2608. While communication connection 2620 is shown for illustrative clarity inside computer 2602, it can also be external to computer 2602. The hardware/software necessary for connection to the network interface 2622 includes, for exemplary purposes only, internal and external technologies such as, modems including regular telephone grade modems, cable modems and DSL modems, ISDN adapters, and wired and wireless Ethernet cards, hubs, and routers.

In regard to the various functions performed by the above described components, machines, devices, processes and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the embodiments. In this regard, it will also be recognized that the embodiments include a system as well as electronic hardware configured to implement the functions, or a computer-readable medium having computer-executable instructions for performing the acts or events of the various processes.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

In other embodiments, combinations or sub-combinations of the above disclosed embodiments can be advantageously made. The block diagrams of the architecture and flow charts are grouped for ease of understanding. However, it should be understood that combinations of blocks, additions of new blocks, re-arrangement of blocks, and the like are contemplated in alternative embodiments of the present disclosure.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A trimmer system for weeds and vegetation configured to be attached to a lawn maintenance apparatus, comprising:
a trimmer head configured to at least one of trim or edge the weeds and the vegetation;
a trimmer arm attached to the trimmer head configured to control a position of the trimmer head; and
a trimmer base configured to connect the trimmer to the lawn maintenance apparatus and to control a position of the trimmer arm relative to the lawn maintenance apparatus.

2. The trimmer system of claim 1, wherein the trimmer head is configured to be positioned alternately into a first position configured to trim the weeds and the vegetation and a second position configured to edge the weeds and the vegetation.

3. The trimmer of claim 1, wherein the trimmer arm comprises one or more springs configured to regulate a pressure of the trimmer head on the ground.

4. The trimmer system of claim 1, wherein the trimmer arm comprises a parallelogram mechanism to maintain an angle of the trimmer head independent of a height of the trimmer head.

5. The trimmer system of claim 1, wherein the trimmer base comprises a suspension mechanism that facilitates the trimmer arm yielding in response to an applied force and returning in response to an absence of the applied force.

6. The trimmer system of claim 1, wherein the trimmer head comprises an adjustable stand-off configured to provide an adjustable distance between the trimmer head and at least one of the ground or an obstacle.

7. The trimmer system of claim 1, wherein the trimmer arm is configured to fold upward into a substantially vertical position.

8. A method of operating a lawn maintenance apparatus with an attached trimmer, comprising:
recording positions of the trimmer attached to the lawn maintenance apparatus along a path;
making a determination to repeat the path; and
autonomously controlling at least one of a position of the lawn maintenance apparatus or the trimmer to repeat the path.

9. The method of claim 8, wherein the positions are recorded via one or more Global Positioning System (GPS) antennas employing Real Time Kinematics (RTK).

10. The method of claim 9, wherein the one or more GPS antennas comprise a first GPS antenna attached to an arm of the trimmer.

11. The method of claim 9, wherein the one or more GPS antennas comprise a first GPS antenna attached to the lawn maintenance apparatus.

12. The method of claim 8, wherein the determination is based at least in part on a current position of the trimmer being within a threshold distance of an end point of the path, wherein the threshold distance is based on a reach of the trimmer.

13. The method of claim 8, wherein autonomously controlling at least one of the position of the lawn maintenance apparatus or the trimmer comprises controlling a steering and a forward motion of the lawn maintenance apparatus.

14. A method of operating a lawn maintenance apparatus with an attached trimmer, comprising:
making a first determination that the trimmer attached to the lawn maintenance apparatus is at an appropriate starting position for at least one of trimming or edging around an obstacle, wherein the trimmer is in contact with the obstacle;
making a second determination that one or more wheels of the lawn maintenance apparatus are turned to an appropriate angle for the at least one of trimming or edging around the obstacle; and
at least one of providing feedback to a user or autonomously controlling the lawn maintenance apparatus to maintain contact between the trimmer and the obstacle as the lawn maintenance apparatus circles the obstacle.

15. The method of claim 14, wherein the first determination is made based on the trimmer being at a tangent point of the obstacle.

16. The method of claim 14, wherein the second determination is made based on a rangefinder of the lawn maintenance apparatus being aimed at a center of the obstacle.

17. The method of claim 14, wherein the at least one of providing feedback to the user or autonomously controlling the lawn maintenance apparatus comprises autonomously controlling a steering of the lawn maintenance apparatus.

18. The method of claim 14, wherein the at least one of providing feedback to the user or autonomously controlling the lawn maintenance apparatus comprises autonomously controlling a forward motion of the lawn maintenance apparatus.

19. The method of claim 14, wherein the at least one of providing feedback to the user or autonomously controlling the lawn maintenance apparatus comprises providing feedback based on a distance between the lawn maintenance apparatus and the obstacle.

20. A method of operating a lawn maintenance apparatus with an attached trimmer, comprising:
making a first determination to begin at least one of trimming or edging with the trimmer along an obstacle in contact with the trimmer;
monitoring a distance between the lawn maintenance equipment and the obstacle; and
in response to a change in the distance between the lawn maintenance apparatus and the obstacle, at least one of providing feedback to a user or autonomously controlling the lawn maintenance apparatus to maintain contact between the trimmer and the obstacle.

21. The method of claim 20, wherein the change in the distance is one of the distance decreasing below a first threshold distance or increasing above a second threshold distance.

22. The method of claim 20, wherein the at least one of providing feedback to a user or autonomously controlling the lawn maintenance apparatus comprises autonomously controlling a steering of the lawn maintenance apparatus.

23. The method of claim 20, wherein the at least one of providing feedback to the user or autonomously controlling the lawn maintenance apparatus comprises autonomously controlling a forward motion of the lawn maintenance apparatus.

24. The method of claim 20, wherein the at least one of providing feedback to the user or autonomously controlling the lawn maintenance apparatus comprises providing feedback based on a distance between the lawn maintenance apparatus and the obstacle.

25. The method of claim 20, wherein monitoring the distance is based on measuring the distance via a rangefinder.

26. A trimmer system for weeds and vegetation, comprising:
a trimmer head configured to at least one of trim or edge the weeds and the vegetation; and
a trimmer arm attached to the trimmer head configured to control a position of the trimmer head,
wherein the trimmer head comprises at least one adjustable stand-off configured to provide an adjustable distance between the trimmer head and at least one of the ground or an obstacle.

27. The trimmer system of claim 26, wherein the trimmer arm is configured to be held by an operator of the trimmer.

28. The trimmer system of claim 26, wherein the trimmer arm is configured to be attached to a lawn maintenance apparatus.

29. The trimmer system of claim 26, further comprising at least one adjustment mechanism for adjusting the at least one adjustable stand-off.

30. The trimmer system of claim 26, wherein the at least one adjustable stand-off comprises one or both of a first adjustable stand-off configured to be employed in connection with trimming or a second adjustable stand-off configured to be employed in connection with edging.
